(19) United States
(12) Patent Application Publication
(10) Pub. No.: US 2002/0159103 A1
(43) Pub. Date: Oct. 31, 2002

(54) Image reading device

(75) Inventors: Makoto Ikeda, Osaka-shi (JP); Takashi Kishimoto, Osaka-shi (JP); Shuya Ogi, Osaka-shi (JP)

Correspondence Address: MERCHANT & GOULD PC, P.O. BOX 2903, MINNEAPOLIS, MN, 55402-0903, US

(73) Assignee: Nippon Sheet Glass Co., Ltd., Osaka (JP)

(21) Appl. No.: 10/132,987

(22) Filed: Apr. 26, 2002

(30) Foreign Application Priority Data
Apr. 27, 2001 (JP) 2001-133161
Mar. 4, 2002 (JP) 2002-056715

(51) Int. Cl. H04N 1/04; H04N 1/46

(52) U.S. Cl. 358/505; 358/474

(57) ABSTRACT

A rod lens array 3, a line image sensor 4, and a line image sensor 5 are provided in such a manner that a distance A1 between a point A of an object surface and one end of a rod lens array 3 is the same as a distance A2 between the other end of the rod lens array 3 and a light-receiving surface (i.e., an image formation surface) of a first line image sensor 4, and a distance B1 between a point B of the object surface and one end of the rod lens array 3 is the same as a distance B2 between the other end of the rod lens array 3 and a light-receiving surface (i.e., an image formation surface) of a second line image sensor 5.

### BACKGROUND OF THE INVENTION

1. Field of the Invention

The present invention relates to an image reading device using a 1:1 (magnification) image formation rod lens array which is provided with many rod lens arrays, and more particularly to an image reading device which can obtain satisfactory MTF (Modulation Transfer Function) characteristics even in the case where an object surface is not perpendicular to the optical axis of the rod lens array.

2. Description of the Prior Art

An image reading device using a rod lens array is disclosed in Japanese Unexamined Patent Publication No. 2000-349955, Japanese Unexamined Patent Publication No. Hei 10-23283 (1998) and the like. In this prior art, an object surface (i.e., a surface on which an image subject such as a document and/or an image is placed; a surface to be imaged) is provided perpendicular to the optical axis of the rod lens array. An image formation surface is provided perpendicular to the optical axis of the rod lens array, and a light-receiving surface of an image sensor is placed on the image formation surface.

On the contrary, there is a case where the object surface is not provided perpendicular to the optical axis of the rod lens array, but used in an inclined condition from the perpendicular. By providing the rod lens array slantingly relative to the object surface, it is possible to miniaturize the image-reading device. It is suggested in Japanese Unexamined Patent Publication No. Hei 11-215300 (1999) that the image-reading device (i.e., an image pick-up device unit) be miniaturized by respectively arranging a source of light, the rod lens array, and an image pick-up device (i.e., an image sensor) at an angle of θ relative to a surface to be imaged and contriving a mounting position and direction of the image pick-up device.

FIG. 10 is a view showing a problem of the image reading device with a structure in which the rod lens array is arranged slantingly relative to the object surface. An image reading device 100 shown in FIG. 10 is provided, in which a frame 1 made of a black resin is provided with a document stand 2 made of a transparent resin and a rod lens array 3. Secured to the lower surface of the frame 1 is a base plate 8 made of glass epoxy resin which supports each of line sensors (i.e., line image sensors) 4, 5 and a light-emitting diode (i.e., a source of illumination) 7 provided with a light projecting lens 6. Reference numeral 7a is a terminal of the light-emitting diode (LED).

This image reading device 100 performs the image reading of an image subject by irradiating the illumination light emitted from a light-emitting diode (i.e., a source of illumination) 7 on the image subject (not shown) to be placed on the document stand 2, receiving the reflection light at each light-receiving surface of line sensors 4, 5 through the rod lens array 3, and converting the reflection light to an electric signal.

FIG. 10 shows a case where the rod lens array is provided at an angle of 45°. Line sensors 4, 5 are respectively provided at the position of image formation surfaces A″, B″ where a document or an image placed on object surfaces A, B is image-formed.

As shown in FIG. 10, reference is now made to a case where each of the object surface and the image formation surface inclines at the same angle from an optical axis of an image formation lens.

FIG. 11 is a view showing the action of an image formation optical system using a convex lens. Normally, the image formation optical system using a general lens (i.e., the convex lens) forms an inverted image, as shown in FIG. 11, on the object surface and the image formation surface which are distance by 2f (f is the focus distance) from each other. Namely, points A, B of the object surface are respectively imaged at the position of points A′, B′ of the image formation surface. Further, a second image formation optical system in which the image formation surface is a second object surface forms an erecting image of points A, B at points A″, B″. Accordingly, in the case of the erecting image formation optical system using a general lens optical system, it is considered that the relationship of θ=θ′ is established concerning the tilt angle of an optical system shown in FIG. 11. Namely, the image formation surface is parallel to the object surface.

However, when an image formation lens is a rod lens, the optical system shown in FIG. 10 is not suitable. The reason is described below.

In the optical system shown in FIG. 10, since the object surface is parallel to the image formation surface, the distance between A and A″ is the same as that between B and B″. This distance is hereinafter referred to as an object image surface distance (total conjugate or separation between object and image) TC. The object image surface distance TC is expressed by the formula of TC=Z+2L when the length of the rod lens is Z and the working distance of the rod lens is L. Now, the working distance L is the distance from an intermediate point between A and B to one end of the object surface side of the rod lens, or the distance from an intermediate point between A″ and B″ to one end of the image formation surface side of the rod lens.

In FIG. 10, when the inclination of the object surface and the image formation surface relative to the optical axis of the rod lens is taken as a deviation ΔL of a focal point, the distance A1 from the object surface to one end of the rod lens and the distance A2 from one end of the rod lens to the image formation surface between A and A″ are expressed in the formulas A1=L+ΔL and A2=L−ΔL. On the other hand, the distance B1 from the object surface to one end of the rod lens and the distance B2 from one end of the rod lens to the image formation surface between B and B″ are expressed in the formulas B1=L−ΔL and B2=L+ΔL.

Namely, in the optical system shown in FIG. 10, the distance from the object surface to the image formation surface is constant (i.e., TC). However, the rod lens array deviates toward the image formation side (i.e., A″ side) by ΔL between A and A″ and deviates toward the object surface side (i.e., B side) by ΔL between B and B″.

FIG. 12 (a) is a view corresponding to an optical system in which the object image surface distance TC is constant and the rod lens array deviates by the distance ΔL, and FIG. 12 (b) is a view showing MTF characteristics of that optical system. It is observed from a graph shown in FIG. 12 (b) that in the optical system shown in FIG. 10, deterioration of the MTF characteristics is remarkable relative to the deviation of the rod lens array. When the MTF characteristics deteriorate, quality (i.e., the resolving power) of image to be read deteriorates.

### SUMMARY OF THE INVENTION

It is therefore an object of the present invention to solve the problems stated above and to improve MTF characteristics in the case where in an image formation optical system using a rod lens array, an object surface is not perpendicular to an optical axis of the rod lens array.

To solve the problems, an image reading device according to the present invention is provided, in which the object surface inclines relative to an optical axis of a rod lens array, wherein a first point A on the object surface is read by a first image sensor through the rod lens array, and a second point B on the object surface is read by a second image sensor through the rod lens array, characterized in that a distance parallel to the optical axis between the point A and one end of the rod lens array on the side of the object surface is A1, a distance parallel to the optical axis between the point B and one end of the rod lens array on the side of the object surface is B1, a distance parallel to the optical axis between a light-receiving surface of the first image sensor and one end of the rod lens array on the side of the image sensor A2, and a distance parallel to the optical axis between the light-receiving surface of the second image sensor and one end of the rod lens array on the side of the image sensor is B2, wherein the object surface, the rod lens array, and the image sensor are arranged to have the relation of A1>B1 and A2>B2. In this case, the best mode is when the distance A1 and the distance A2 are arranged to be the same, and the distance B1 and the distance B2 are arranged to be the same.

The distance A1 and the distance A2 are set to be longer by a predetermined distance ΔL than a working distance L of the rod lens array, while the distance B1 and the distance B2 are set to be shorter by a predetermined distance ΔL than the working distance L of the rod lens array.

If the object surface, the rod lens array, and the image sensor are arranged to meet the above relationship, it is possible to locate each point A and B and each light-receiving surface of the image sensors within a focal depth of the rod lens array so that the MTF characteristics can be maintained in a satisfactory condition.

Further, the object surface is arranged to incline at an angle θ from the direction perpendicular to the optical axis of the rod lens array, and each image sensor is arranged to incline a normal line of the light-receiving surface in the direction −θ relative to the optical axis of the rod lens array.

Still further, in the case where the object surface inclines at an angle θ from the direction perpendicular to the optical axis of the rod lens array, a transparent resin with a refractive index n is inserted between the object surface and the rod lens array, and there is air between the rod lens array and each image sensor, an angle θ′ between the light-receiving surface of each image sensor and a surface perpendicular to the optical axis of the rod lens array is set to satisfy the formula θ′=tan⁻¹[(tan θ)/n].

Transparent members having the same refractive index can be inserted between the object surface and the rod lens array, and between the rod lens array and the light-receiving surface of each image sensor, respectively. In this case, it is not necessary to correct the angle θ between the light-receiving surface of each image sensor and the surface perpendicular to the optical axis of the rod lens array relative to the above-mentioned angle θ.

Further, the rod lens array and the image sensor can be arranged so that the distance A2 and the distance B2 are the same. In this manner, it is possible to reduce the deterioration of the MTF characteristics.

### BRIEF DESCRIPTION OF THE DRAWINGS

The above and other objects, features and advantages of the present invention will become more apparent from the following description when taken in conjunction with the accompanying drawings.

FIG. 1 is a cross-sectional view of an image reading device according to a first embodiment of the present invention;

FIG. 2(a) is a view corresponding to an optical system whereby the distance between an object surface and an image formation surface has increased or decreased from an object image surface distance TC, and FIG. 2 (b) is a view showing MTF characteristics of that optical system;

FIG. 3 is a cross-sectional view showing a modification of the first embodiment;

FIG. 4 is a cross-sectional view showing a modification of the first embodiment;

FIGS. 5 (a) and (b) are perspective views showing modifications of a licensor;

FIG. 6 is a cross-sectional view of an image reading device according to a second embodiment of the present invention;

FIG. 7 is a cross-sectional view showing a modification of the second embodiment;

FIG. 8 (a) is a view corresponding to an optical system whereby the distance from an image formation surface to a central position of a rod lens is TC/2, and the distance from an object surface to the image formation surface has increased or decreased relative to TC on the object surface side, and FIG. 8 (b) is a view showing MTF characteristics of that optical system;

FIG. 9 is a view showing correction of an inclination angle of the image formation surface;

FIG. 10 is a view showing a problem of the image reading device having a structure in which the rod lens array is arranged slantingly relative to the object surface;

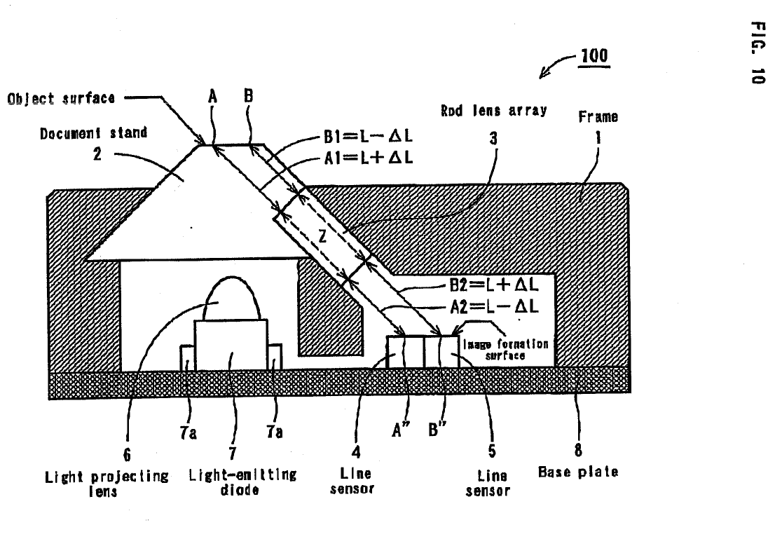

FIG. 11 is a view showing an action of an image formation optical system using a convex lens; and

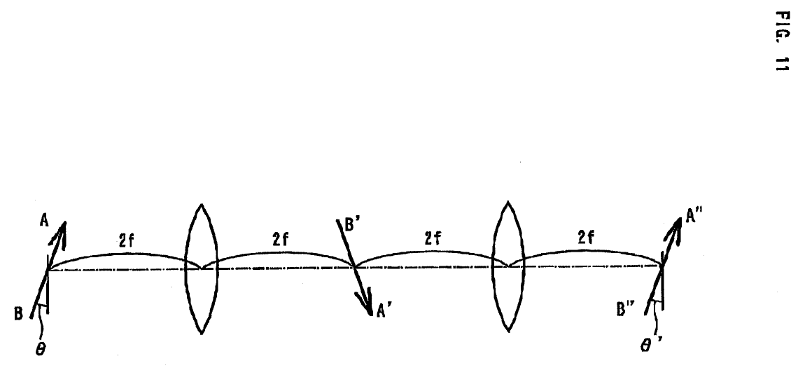

FIG. 12 (a) is a view corresponding to an optical system whereby the object image surface distance TC is constant and the rod lens array deviates by a distance ΔL, and FIG. 12 (b) is a view showing MTF characteristics of that optical system.

### DETAILED DESCRIPTION OF THE PREFERRED EMBODIMENTS

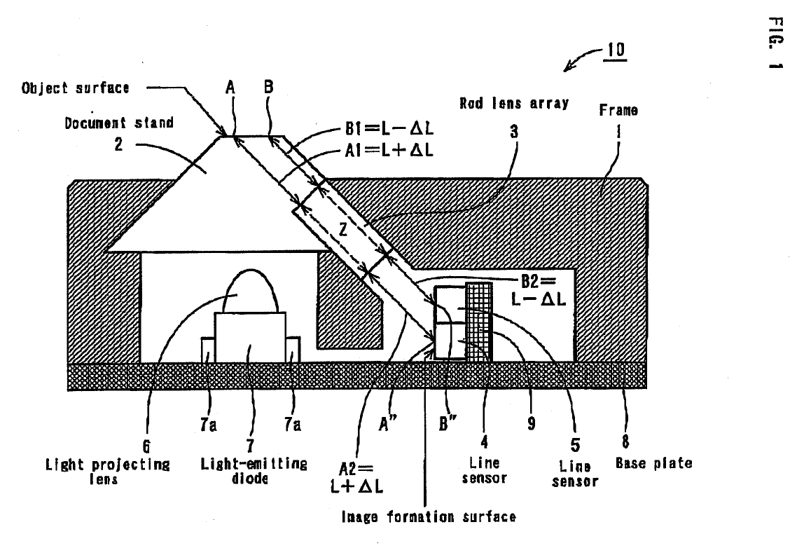

Preferred embodiments of the present invention will now be described with reference to the accompanying drawings. FIG. 1 is a cross-sectional view of an image reading device according to a first embodiment of the present invention. In the image reading device 10 according to the first embodiment, an object surface an image formation surface are provided to incline at the same angle (45°) relative to an optical axis of a rod lens array 3 and arranged in the direction in which points A and A″ are distant from the rod lens array 3, while points B an B″ come close to the rod lens array 3. Line sensors 4, 5 are respectively installed through an auxiliary base plate 9 so that the image formation surface is perpendicular to the object surface.

In FIG. 1, if the inclination of the object surface and the image formation surface relative to the optical axis of the rod lens array 3 is taken as a deviation ΔL of a focal point, since points A and A″ deviate by ΔL in the direction in which they are distant from the rod lens array 3 between points A and A″, the relation A1=A2=L+ΔL is established. On the other hand, since points B and B″ deviate by ΔL in the direction in which they come close to the rod lens array 3 between points B and B″, the relation B1=B2=L−ΔL is established.

An optical system of the image reading device 10 shown in FIG. 1 is explained as follows. The distance between an intermediate point between the points A and B and an intermediate point between the points A″ and B″ is TC. The distance between the points A and A″ increases or is longer by 2×ΔL than TC and the distance between the points B and B″ decreases or is shorter by 2×ΔL than TC.

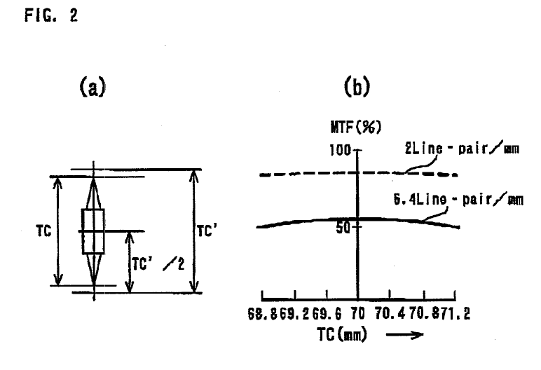

FIG. 2 (a) is a view corresponding to an optical system whereby the distance between the object surface and the image formation surface has increased or decreased from an object image surface distance TC, and FIG. 2 (b) is a view showing MTF characteristics of that optical system. Since the optical system shown in FIG. 1 corresponds to the optical system shown in FIG. 2 (a), the MTF characteristics shown in FIG. 2 (b) are applied to the optical system shown in FIG. 1. Accordingly, it is possible to satisfactorily maintain the MTF characteristics relative to the deviation (i.e., the deviation of ΔL) of the object image surface distance TC.

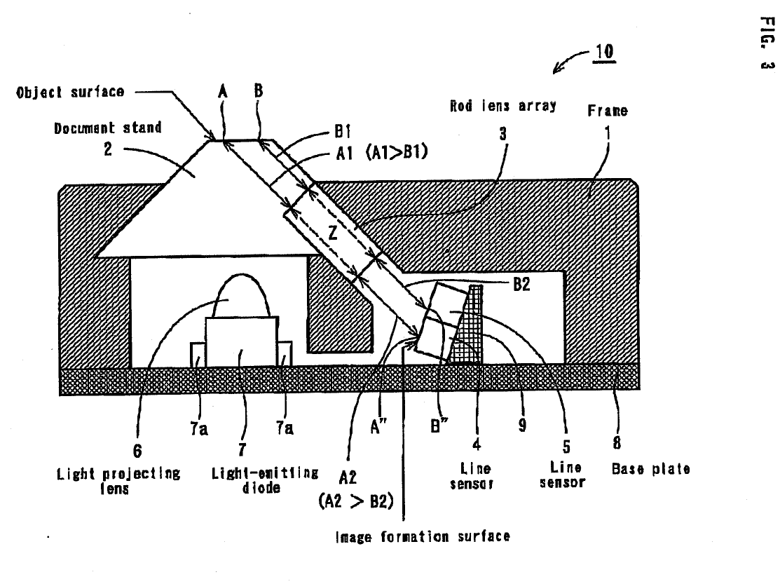

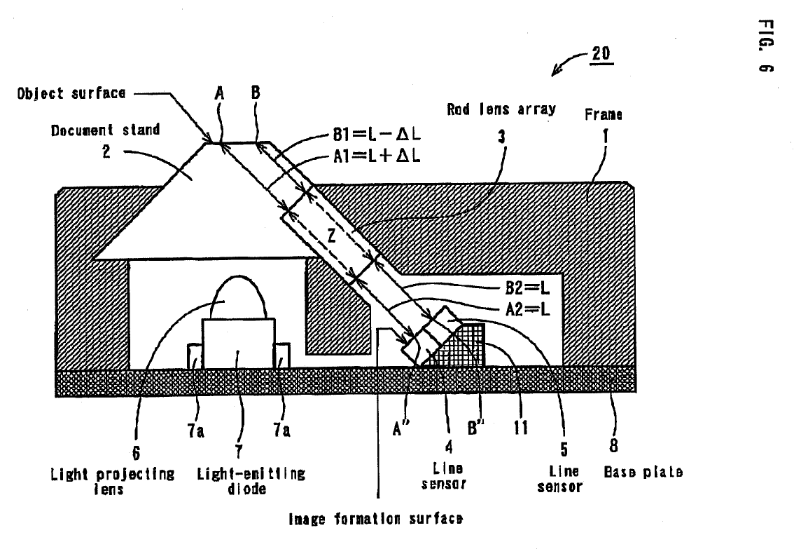

FIG. 3 is a cross-sectional view showing a modification of the first embodiment. In this embodiment, the relation of A1>B1 and A2>B2 is established. In such a configuration, the MTF characteristics are inferior to those shown in FIG. 1, but an image reading device of which the MTF characteristics are superior to those shown in FIG. 6 can be obtained.

To establish the above-mentioned relationship, the image formation surface is caused to incline within the range of 0° or more and 45° or less from a condition of FIG. 1 relative to the direction perpendicular to an optical axis of the rod lens array 3 (i.e., FIG. 6 shows a condition in which the inclination is 0°, and FIG. 1 shows a condition in which the inclination is 45°). Namely, the relation of A1>B1 and A2>B2 is established by having the formulae A1=L+ΔL1, B1=L−ΔL1, A2=L+ΔL2, and B3=L−ΔL2 (provided that ΔL1≠L2). In this case, it is to be understood that the object surface can be inclined within the range of 0° or more and 45° or less relative to the direction of the optical axis of the rod lens array 3 in place of the image formation surface. Further, a direction for inclining the image formation surface or the object surface from the direction perpendicular to the optical axis of the rod lens array 3 is the direction which meets the relation of A1>B1 ad A2>B2.

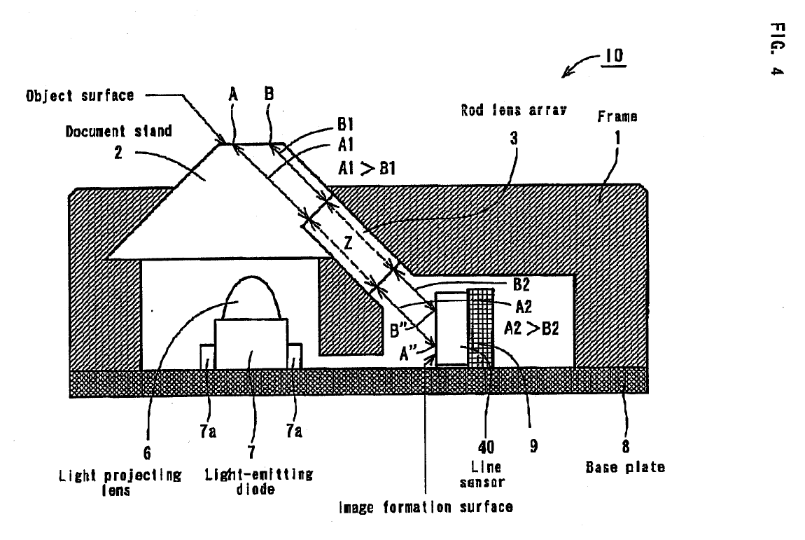

As shown in FIG. 4, it is also possible to establish the relation A1>B1 and A2>B2 by moving the rod lens array 3 along the optical axis from the condition of FIG. 1.

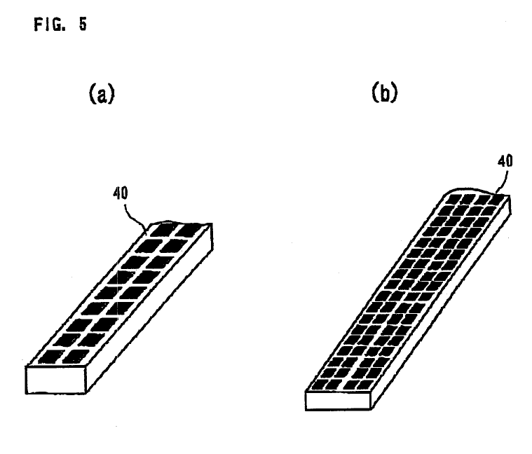

In the first embodiment, two line sensors 4, 5 are arranged in a line. However, they are interchangeable with a line sensor 40 shown in FIG. 5 (a) in which two lines of light receiving elements are arranged on one chip in a line, or another line sensor 40 shown in FIG. 5 (b) in which multiple lines of light receiving elements are arranged on one chip in a line.

FIG. 6 is a cross-sectional view of an image reading device according to a second embodiment of the present invention. In an image reading device 20 according to the second embodiment, an object surface is provided to incline at a predetermined degree (i.e., in this embodiment, 45° from the direction perpendicular to the optical axis) relative to the optical axis of the rod lens array 3, and an image formation surface is arranged perpendicular to the optical axis of the rod lens array 3. Line sensors 4, 5 are respectively mounted through a line sensor mounting section 11 provided with an auxiliary base plate so that the image formation surface is perpendicular to the optical axis of the rod lens array 3.

In the optical system of the image reading device 20 according to the second embodiment, if the inclination of the object surface and the image formation surface relative to the optical axis of the rod lens array 3 is taken as the deviation ΔL of a focal point, since a point A deviates by ΔL in the direction away from the lens array 3 between points A and A″, the relation is A1=L+Δ and A2=L. Since a point B deviates in the direction coming close to the rod lens array 3 between points B and B″, the relation is B1=L−ΔL and B2=L. Herein, since the image formation surface is provided perpendicular to the optical axis of the rod lens array 3, the distance from one end of the rod lens to the image formation surface is L both in A2 and in B2.

Namely, the optical system of the image reading device 20 shown in FIG. 6 becomes as follows. The distance from an intermediate point between points A and B to the central position of the rod lens is TC/2. The distance between points A and A″ is longer (i.e., increases) by ΔL than TC on the object surface side (i.e., a point A side), while the distance between points B and B″ is shorter (i.e., decreases) by ΔL than TC on the object side (i.e., a point B side).

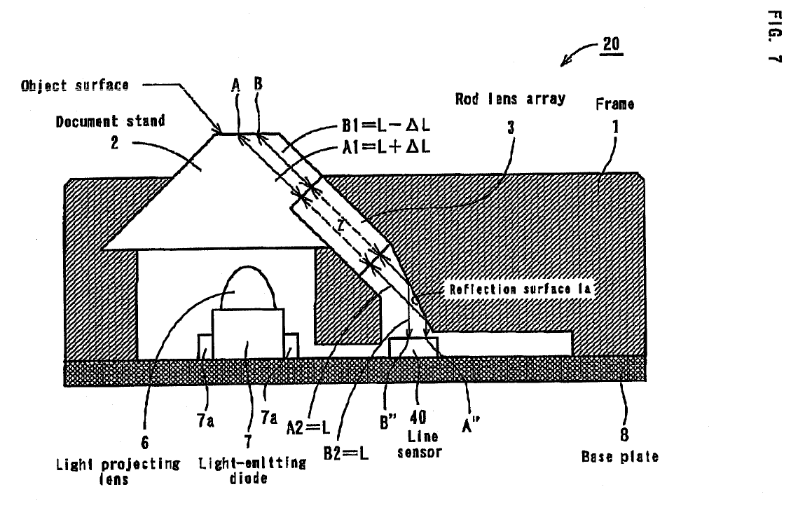

FIG. 7 is a cross-sectional view showing another modification of the second embodiment in which a surface forming an optical path of a frame 1 serves as a reflection surface 1a. Namely, since the rod lens array 3 inclines at an angle of 45° form a normal line of a base plate 8, the reflection surface 1a is provided at an angle of 22.5° from the normal line of the base plate 8. As a result, the light emitted from the rod lens array 3 enters in the direction perpendicular to the base plate 8. Accordingly, since the light-receiving surface of the line sensor 40 is provided parallel to the surface of the base plate 8, it is possible to receive the light efficiently and as a result, the line sensor mounting section 11 can be eliminated. It is also possible to simplify the shape of line sensor and make the assembling operation easier.

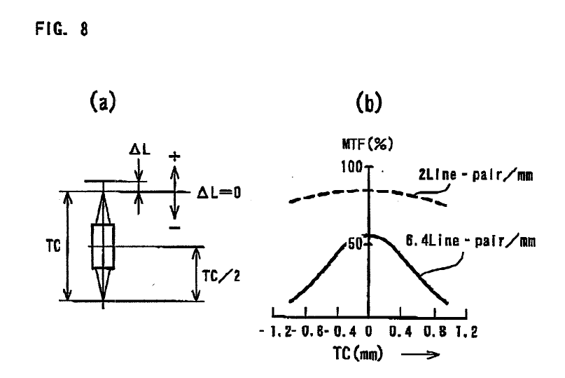

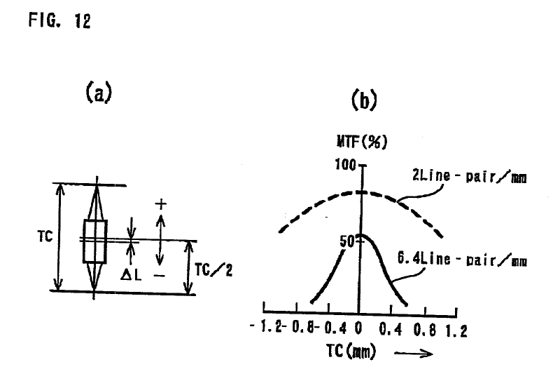

FIG. 8 (a) is a view corresponding to an optical system whereby the distance from an image formation surface to a central position of the rod lens is TC/2 and the distance from the object surface to the image formation surface has increased or decreased relative to the TC on the object surface side, and FIG. 8 (b) is a view showing MTF characteristics of that optical system. Since the optical system shown in FIG. 6 corresponds to that shown in FIG. 8 (a) and exhibits the MTF characteristics shown in FIG. 8 (b), the deterioration of MTF characteristics relative to the deviation ΔL is less compared with FIG. 12.

In the image reading devices 10, 20 shown in FIGS. 1, 3, 6 and 7, there is a resin (e.g., an acrylic resin; refractive index: 1.49) between the object surface and the rod lens array 3, and only air between the rod lens array 3 and the image formation surface. It is therefore necessary to correct the optical system.

The direction of inclination of the image formation surface relative to the lens optical axis is inclined in the direction opposite to an erecting image optical system by an ordinary lens. In an erecting 1:1 image formation system by a convex lens, when the normal line of the object surface inclines relative to the optical axis (i.e., this angle is θ), the normal line of the image formation surface also inclines by θ in the same direction. On the other hand, in the image formation optical system using the rod lens array, it is necessary to incline the normal line of the image formation surface in the direction −θ. Namely, the tilt angle is opposite to the erecting 1:1 image formation system by a general convex lens.

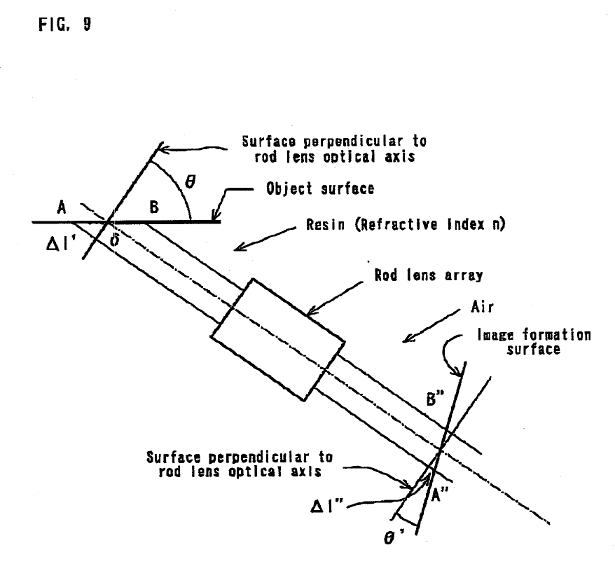

FIG. 9 is a view showing the correction of the inclination angle of the image formation surface. In the optical system of the image reading device shown in FIG. 1, when the object surface inclines at an angle θ form the direction perpendicular to the optical axis of the rod lens, it is necessary to correct the inclination angle θ′ of the image formation surface. When a resin of refractive index n is provided between the object surface and the rod lens and air is provided between the rod lens and the image formation surface, the inclination angle θ′ of the image formation surface is set as shown in the following formula (5).

On the side of the object surface, the following formula (1) is established:

tan θ=Δ1′/δ (1)

On the side of the image formation surface, the following formula (2) is established:

tan θ′=Δ1″/δ (2)

If the refractive index of the resin is n,

Δ1′=n·Δ1″ (3)

Using the formulae (1) and (3), if the formula (2) is expressed by θ,

tan θ′=Δ1′/n·δ=(1/n)tan θ (4)

Using the formula (4), the inclination angle θ′ of the image formation surface on the side of the image formation surface can be defined from the following formula (5):

θ′=tan⁻¹[(tan θ)/n] (5)

In the image reading devices 10, 20 shown in FIGS. 1 and 6, if a resin (made of an acrylic resin; refractive index=1.49) is inserted between the rod lens array 3 and the image formation surface (i.e., the light-receiving surface of each line image sensor 4, 5), the above correction is not needed.

If a document stand 2 is transparent, the acrylic resin can be replaced by a silicon resin.

As described above, according to the present invention, the object surface and the image formation surface are suitably arranged relative to the optical axis of the rod lens array. Accordingly, even though the object surface is an optical system which is not perpendicular to the optical axis of the rod lens array, it is possible to make the MTF characteristics satisfactory and as a result, the image reading of high resolution can be realized.

What is claimed is:

1. An image reading device in which an object surface inclines relative to an optical axis of a rod lens array, wherein a first point A on the object surface is read by a first image sensor through the rod lens array and a second point B on the object surface is read by a second image sensor through the rod lens array, characterized in that:
a distance parallel to the optical axis between the point A and one end of the rod lens array on the side of the object surface is A1;
a distance parallel to the optical axis between the point B and one end of the rod lens array on the side of the object surface is B1;
a distance parallel to the optical axis between a light-receiving surface of the first image sensor and one end of the rod lens array on the side of the image sensor is A2, and
a distance parallel to the optical axis between a light-receiving surface of the second image sensor and one end of the rod lens array on the side of the image sensor is B2,
wherein the object surface, the rod lens array, and the image sensor are provided in the relation A1>B1 and A2>B2.

2. An image reading device in which an object surface inclines relative to an optical axis of a rod lens array, wherein a first point A on the object surface is read by a first image sensor through the rod lens array, and a second point B on the object surface is read by a second image sensor through the rod lens array, characterized in that:
a distance parallel to the optical axis between the point A and one end of the rod lens array on the side of the object surface is A1;
a distance parallel to the optical axis between the point B and one end of the rod lens array on the side of the object surface is B1;
a distance parallel to the optical axis between a light-receiving surface of the first image sensor and one end of the rod lens array on the side of the image sensor is A2; and
a distance parallel to the optical axis between a light-receiving surface of the second image sensor and one end of the rod lens array on the side of the image sensor is B2;
wherein the object surface, the rod lens array, and the image sensor are provided in such a manner that the distance A1 and the distance A2 are the same, and the distance B1 and the distance B2 are the same.

3. The image reading device according to claim 2, wherein the distance A1 and the distance A2 are longer by a predetermined distance ΔL than a working distance L of the rod lens array, and the distance B1 and the distance B2 are shorter by a predetermined distance ΔL than the working distance L of the rod lens array.

4. The image reading device according to claim 2, wherein the object surface is provided in incline at an angle θ form the direction perpendicular to the optical axis of the rod lens array, and each image sensor is provided to incline a normal line of the light-receiving surface in the direction of −θ relative to the optical axis of the rod lens array.

5. The image reading device according to claim 1 or claim 2, wherein when the object surface inclines at an angle θ from the direction perpendicular to the optical axis of the rod lens array, a transparent resin with a refractive index n is inserted between the object surface and the rod lens array, and air is provided between the rod lens array and each image sensor, an angle θ′ between the light-receiving surface of each image sensor and a surface perpendicular to the optical axis of the rod lens array is set to satisfy the formula θ′=tan⁻¹[(tan θ)/n].

6. The image reading device according to claim 1 or claim 2, wherein transparent members with the same refractive index are inserted between the object surface and the rod lens array, and between the rod lens array and the light-receiving surface of each image sensor, respectively.

7. An image reading device in which an object surface inclines relative to an optical axis of a rod lens array, wherein a first point A on the object surface is read by a first image sensor through the rod lens array, and a second point B on the object surface is read by a second image sensor through the rod lens array, characterized in that:
a distance parallel to the optical axis between a light-receiving surface of the first image sensor and one end of the rod lens array on the side of the image sensor is A2; and
a distance parallel to the optical axis between a light-receiving surface of the second image sensor and one end of the rod lens array on the side of the image sensor is B2;
wherein the rod lens array and the image sensor are provided in such a manner that the distance A2 and the distance B2 are the same.

8. The image reading device according to claim 7, wherein transparent members with the same refractive index are inserted between the object surface and the rod lens array, and between the rod lens array and the light-receiving surface of each image sensor, respectively.
